(19) United States
(12) Patent Application Publication
(10) Pub. No.: US 2008/0088962 A1
(43) Pub. Date: Apr. 17, 2008

(54) Detection of HDI in disk drives using read back signal

(75) Inventor: Debasis Baral, San Jose, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/582,925

(22) Filed: Oct. 17, 2006

(51) Int. Cl. G11B 15/04

(52) U.S. Cl. 360/60

(57) ABSTRACT

A hard disk drive that is capable of inhibiting a write operation when a varying fly height is detected. The disk drive includes a filter circuit that filters a read signal read from a disk. By way of example, the filter circuit may be a low pass filter with a frequency range of 40 to 300 KHz. If the flying height is varying, for example in response to vibration in the drive, the read signal will have a low frequency component. The low pass filter will output the low frequency component. The existence of the low frequency component will cause the disk drive to inhibit a write operation on the disk.

### BACKGROUND OF THE INVENTION

1. Field of the Invention

The present invention relates to writing data onto a disk of a hard disk drive.

2. Background Information

Hard disk drives contain a plurality of magnetic heads that are coupled to rotating disks. The heads write and read information by magnetizing and sensing the magnetic fields of the disk surfaces. Each head is attached to a flexure arm to create a subassembly commonly referred to as a head gimbal assembly (“HGA”). The HGA's are suspended from an actuator arm. The actuator arm has a voice coil motor that can move the heads across the surfaces of the disks.

During operation, each head is separated from a corresponding disk surface by an air bearing. The air bearing eliminates mechanical interference between the head and the disks. The strength of the magnetic field is inversely proportional to the height of the air bearing. A smaller air bearing results in a stronger magnetic field on the disk, and vice versa.

The height of an air bearing may vary during the operation of the drive. For example, a shock load on the drive may create a vibration that causes the heads to mechanically resonate. The vibration causes the heads to move toward and then away from the disk surfaces in an oscillating manner. Particles or scratch ridges in the disk may also cause oscillating movement of the heads. The oscillating movement may occur in either a vertical or in-plane direction relative to the flexure arm.

If oscillation of the heads occurs during a write routine of the drive, the resultant magnetic signal will have an amplitude that varies inversely relative to the movement of the heads. The varying magnetic strength may result in poor writing of data when the signal is read back by the drive. It would be desirable to sense variations in the fly height of a head and prevent writing during excessive resonant movement of the heads.

### BRIEF SUMMARY OF THE INVENTION

A hard disk drive with a filter circuit that filters a signal read by a head of the drive. The disk drive further has a circuit that inhibits a write operation if the filtered written signal has a predetermined characteristic.

### BRIEF DESCRIPTION OF THE DRAWINGS

FIG. 1 is a top view of an embodiment of a hard disk drive;

FIG. 2 is a top enlarged view of a head of the hard disk drive;

FIG. 3 is a schematic of an electrical circuit for the hard disk drive;

FIG. 4 is a graph showing a written signal with a varying flying height;

FIG. 5 is a graph showing an output of a low pass filter;

FIG. 6 is a flow chart of a write operation.

### DETAILED DESCRIPTION

Disclosed is a hard disk drive that is capable of inhibiting a write operation when a varying fly height is detected. The disk drive includes a filter circuit that filters a read signal read from a disk. By way of example, the filter circuit may be a low pass filter with a frequency range of 40 to 300 KHz. If the flying height is varying, for example in response to vibration in the drive, the read signal will have a low frequency component. The low pass filter will output the low frequency component. The existence of the low frequency component will cause the disk drive to inhibit a write operation on the disk. In this manner the drive does not perform a write operation while the head is undergoing mechanical resonance.

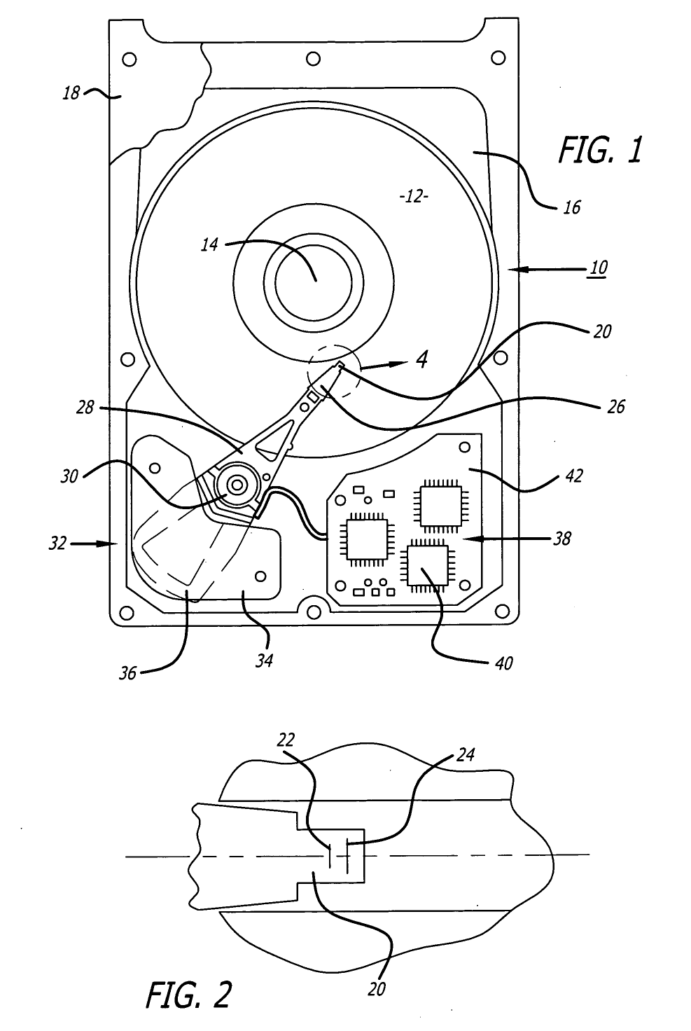

Referring to the drawings more particularly by reference numbers, FIG. 1 shows an embodiment of a hard disk drive 10. The disk drive 10 may include one or more magnetic disks 12 that are rotated by a spindle motor 14. The spindle motor 14 may be mounted to a base plate 16. The disk drive 10 may further have a cover 18 that encloses the disks 12.

The disk drive 10 may include a plurality of heads 20 located adjacent to the disks 12. As shown in FIG. 2 the heads 20 may have separate write 22 and read elements 24. The write element 22 magnetizes the disk 12 to write data. The read element 24 senses the magnetic fields of the disks 12 to read data. By way of example, the read element 24 may be constructed from a magneto-resistive material that has a resistance which varies linearly with changes in magnetic flux.

Referring to FIG. 1, each head 20 may be gimbal mounted to a flexure arm 26 as part of a head gimbal assembly (HGA). The flexure arms 26 are attached to an actuator arm 28 that is pivotally mounted to the base plate 16 by a bearing assembly 30. A voice coil 32 is attached to the actuator arm 28. The voice coil 32 is coupled to a magnet assembly 34 to create a voice coil motor (VCM) 36. Providing a current to the voice coil 32 will create a torque that swings the actuator arm 28 and moves the heads 20 across the disks 12.

The hard disk drive 10 may include a printed circuit board assembly 38 that includes a plurality of integrated circuits 40 coupled to a printed circuit board 42. The printed circuit board 40 is coupled to the voice coil 32, heads 20 and spindle motor 14 by wires (not shown).

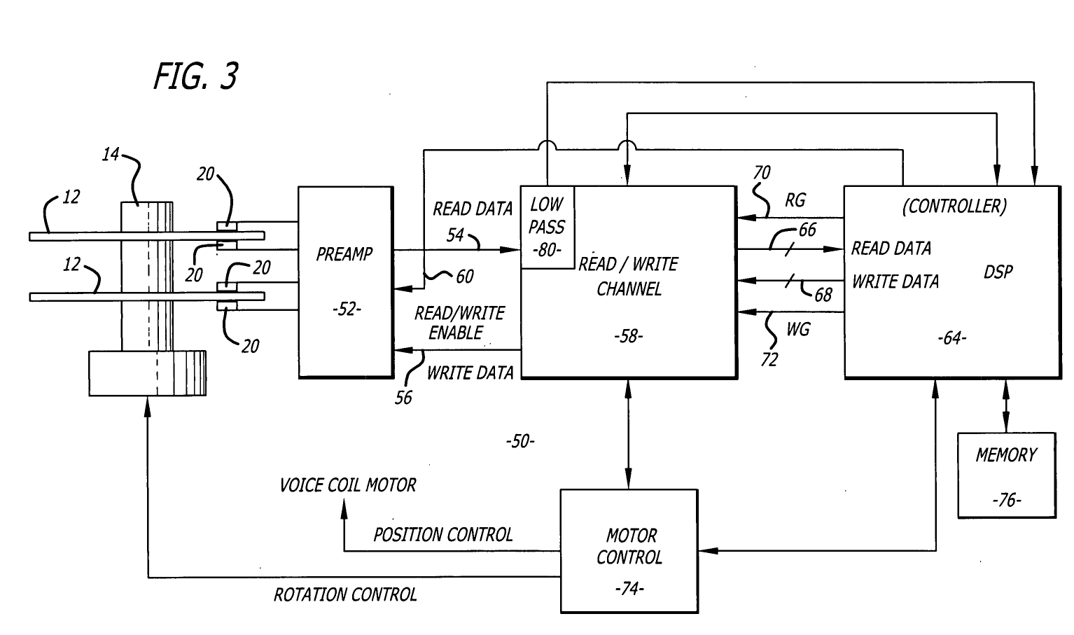

FIG. 3 shows an embodiment of an electrical circuit 50 for reading and writing data onto the disks 12. The circuit 50 may include a pre-amplifier circuit 52 that is coupled to the heads 20. The pre-amplifier circuit 52 has a read data channel 54 and a write data channel 56 that are connected to a read/write channel circuit 58. The pre-amplifier 52 also has a read/write enable gate 60 connected to a controller 64. Data can be written onto the disks 12, or read from the disks 12 by enabling the read/write enable gate 60.

The read/write channel circuit 62 is connected to a controller 64 through read and write channels 66 and 68, respectively, and read and write gates 70 and 72, respectively. The read gate 70 is enabled when data is to be read from the disks 12. The write gate 72 is to be enabled when writing data to the disks 12. The controller 64 may be a digital signal processor that operates in accordance with a software routine, including a routine(s) to write and read data from the disks 12. The read/write channel circuit 62 and controller 64 may also be connected to a motor control circuit 74 which controls the voice coil motor 36 and spindle motor 14 of the disk drive 10. The controller 64 may be connected to a non-volatile memory device 76. By way of example, the device 76 may be a read only memory (“ROM”) that contains instructions that are read by the controller 64.

The read channel 58 may include a low pass filter 80 connected to the read data channel 54 of the preamp 52. The low pass filter 80 filters the incoming read signal read from the disks 12. By way of example, the low pass filter 80 may pass thru frequencies between 40 to 300 KHz. It has been found that any mechanical modulation of the heads and resultant variations of the flying height will typically be in this range. The output of the low pass filter 80 can be provided to the controller 64. If the output is indicative of head modulation then the controller 64 may inhibit any subsequent write operation of the drive 10.

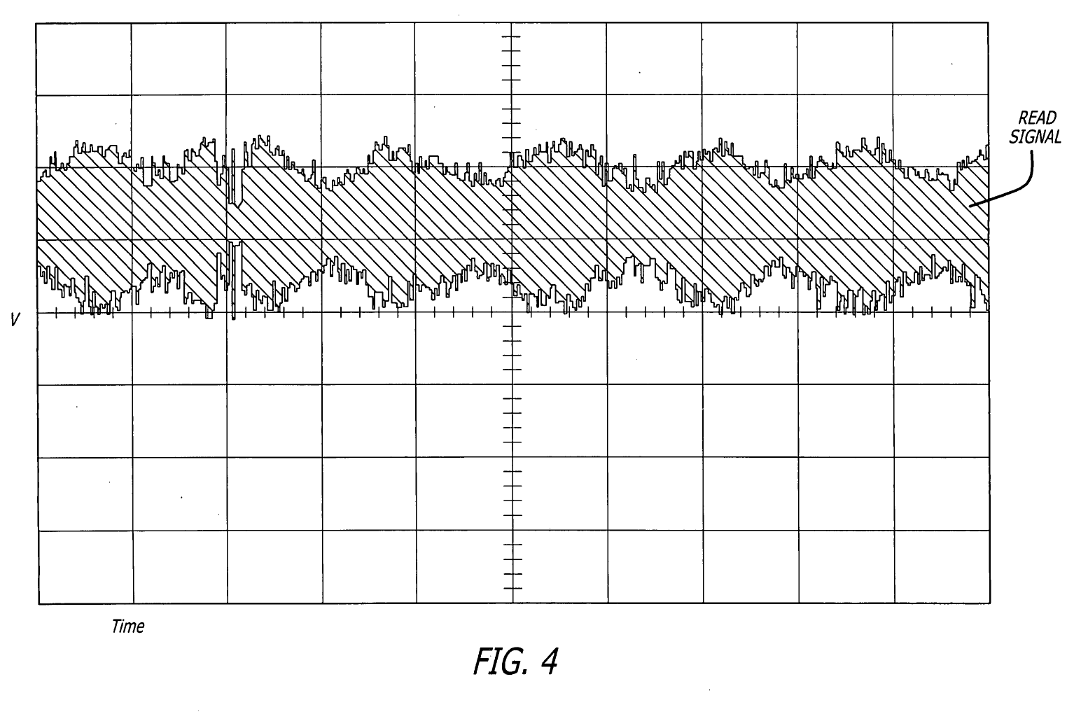

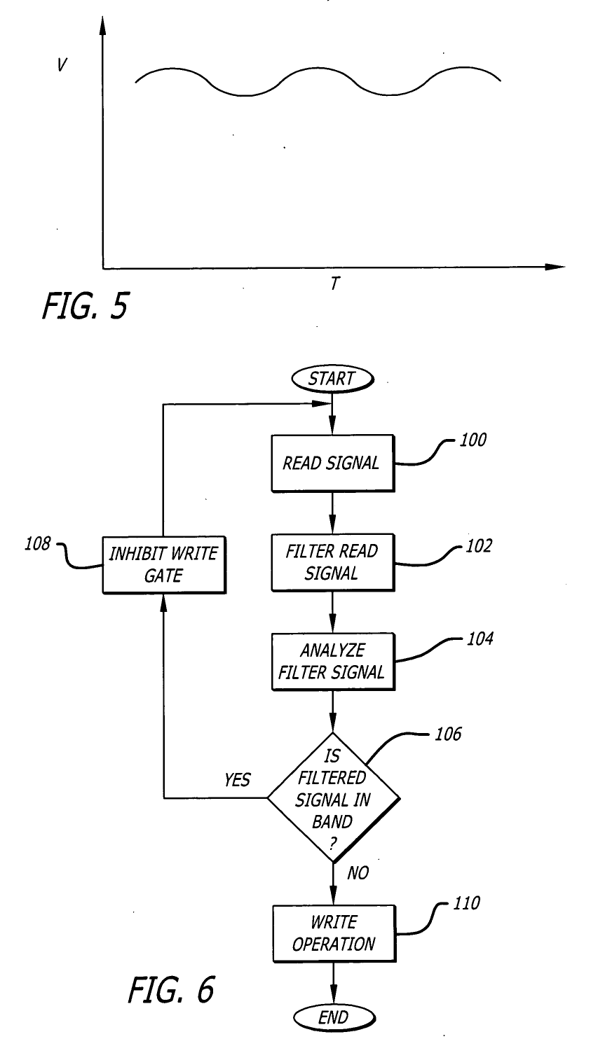

FIG. 4 is a graph that shows a read signal that is modulated by a variation in the fly height of the head. As can be seen, the waveform has a low frequency component. The low pass filter filters out the high frequency components of the read signal and provides a low frequency waveform as shown in FIG. 5. The waveform may be analyzed by the controller 64 to determine whether the write gate should be inhibited.

It may be desirable to read the disk before each and every write operation to determine whether the head(s) flying height is varying. By inhibiting the write operation during variations in the fly height the drive reduces the probability of writing invalid data.

FIG. 6 is a flow chart of a write operation. In step 100 a read signal is generated through the read element of a head. The read signal is passed thru the low pass filter in step 102. The low pass filter generates an output waveform if the read signal has a frequency component(s) within the band of the low pass filter. The output of the low pass filter is analyzed in step 104. The filtered output may be converted to digital form before being analyzed. In decision step 106 it is determined whether the filter output has a predetermined characteristic. The characteristic could be a frequency component in a predetermined band. If the output does have the predetermined characteristic the write gate may be inhibited in step 108 and the process returns to step 100. If not, a write operation is performed in step 110.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

For example, although the low pass filter is shown in the read channel it is to be understood the filter could a separate circuit, or part of another circuit such as the preamp, or the controller. Additionally, although the output of the filter is described as being analyzed by the controller, the read channel or a separate circuit could analyze the output and inhibit the write gate.

What is claimed is:

1. A hard disk drive, comprising:
a disk that contains a signal;
a spindle motor that rotates said disk;
a head coupled to said disk to read said signal;
a filter that is coupled to said head and filters said read signal; and,
a circuit that inhibits a write operation if said filtered read signal has a predetermined characteristic.

2. The disk drive of claim 1, wherein said filter includes a low pass filter.

3. The disk drive of claim 2, wherein said low pass filter passes a frequency between 40 to 300,000 hertz.

4. The disk-drive of claim 1, wherein said circuit inhibits the write operation if said filtered read signal has a frequency component in a predetermined frequency band.

5. The disk drive of claim 4, wherein said predetermined frequency band corresponds to a varying fly height of said head.

6. The disk drive of claim 1, wherein said filter is part of a read channel circuit that is coupled to said head.

7. A hard disk drive, comprising:
a disk that contains a signal;
a spindle motor that rotates said disk;
a head coupled to said disk to read said signal;
filter means for filtering said read signal; and,
circuit means for inhibiting a write operation if said filtered read signal has a predetermined characteristic.

8. The disk drive of claim 7, wherein said filter means includes a low pass filter.

9. The disk drive of claim 8, wherein said low pass filter passes a frequency between 40 to 300,000 hertz.

10. The disk drive of claim 7, wherein said circuit means inhibits the write operation if said filtered read signal has a frequency component in a predetermined frequency band.

11. The disk drive of claim 10, wherein said predetermined frequency band corresponds to a varying fly height of said head.

12. The disk drive of claim 7, wherein said filter means is part of a read channel circuit that is coupled to said head.

13. A method for controlling a write operation of a hard disk drive, comprising:
reading a signal stored on a disk of a hard disk drive;
filtering the read signal;
determining whether the filtered read signal has a predetermined characteristic;
writing onto the disk if the filtered read signal does not have the predetermined characteristic.

14. The method of claim 13, wherein the read signal is filtered with a low pass filter.

15. The method of claim 14, wherein the low pass filter passes a frequency between 40 to 300,000 hertz.

16. The method of claim 13, wherein the predetermined characteristic is a frequency component in a predetermined frequency band.

17. The method of claim 16, wherein the predetermined frequency band corresponds to a varying fly height of a head that reads the signal from the disk.
